(19) United States
(12) Patent Application Publication
(10) Pub. No.: US 2010/0161467 A1
(43) Pub. Date: Jun. 24, 2010

(54) Personalized lifetime financial planning tool

(75) Inventors: Ilieva I. Ageenko, Cornelius, NC (US); Kelley A. Doherty, Charlotte, NC (US); Adrian Paul Van Cleave, Dallas, NC (US)

Correspondence Address: Wells Fargo;c/o K& L Gates, Hearst Tower, 47th Floor, 214 North Tryon Street, Charlotte, NC, 28202, US

(73) Assignee: Wachovia Corporation, Charlotte, NC (US)

(21) Appl. No.: 12/316,967

(22) Filed: Dec. 18, 2008

(51) Int. Cl. G06Q 40/00

(52) U.S. Cl. 705/35

(57) ABSTRACT

A networked computer system comprising a user, a website of a bank or a financial institution, and a computer software tool. The computer software tool is accessible on the website of the bank or the financial institution and provides personalized lifetime financial planning to the user based upon financial information of the user along with a life event and a life stage of the user in an interactive computer generated timeline. The timeline comprises a past event, a present event, a future event, or a combination thereof of the user. The tool provides an automated reminder to the user based upon information of the user present in the timeline. The user may be a customer of the bank or the financial institution.

### FIELD OF THE INVENTION

The present invention relates to a computer-based personalized lifetime financial planning tool.

### BACKGROUND OF THE INVENTION

Existing methods and products used to provide financial advice do not take into consideration that people change opinions about their needs and wants all the time. Current approaches to financial planning are not dynamic and tend to be task specific. For example, existing products may address discrete events: how to save for a wedding, how to plan for retirement, or how to buy a house or a car. However, existing methods currently lack the ability to capture key periods of time in a person's life and events that have occurred to the person in a macro perspective.

Furthermore, people today are computer-oriented. There is an increasing number of people today who use the internet and world wide web routinely for information gathering, entertainment, shopping, and financial updates. Thus, people have come to desire most services and products to be accessible and available online on the internet. Furthermore, many people want to be able to access their information with electronic mobile devices.

Thus, there is a need for a product that not only overcomes these shortcomings but also addresses the needs of consumers to address their financial planning needs in a fluid, efficient and user-friendly way.

### SUMMARY OF THE INVENTION

The present invention relates to a web-based online computer tool to provide personalized lifetime financial planning to a user. The tool is used in a networked computer system. The system generally comprises a user, a website of a bank or a financial institution, and the computer software tool. The computer software tool is accessible on the website of the bank or the financial institution for providing personalized financial planning to the user. The personalized financial planning is based upon financial information of the user along with a life event and a life stage of the user in an interactive timeline. Preferably, the user is a customer of the bank or the financial institution. The system further comprises a computer database for storing personal information, financial information, life events, goals, or a combination thereof, of the user. The tool may also be used by one or more users to generate a composite timeline based upon the life events and life stages of one or both of the users. The tool optionally provides an automated reminder to the user based upon information of the user present in the timeline.

The present invention is also directed a method of using the computer tool. The method generally comprises offering by a bank or a financial institution a web-based online computer tool comprising an interactive timeline accessible on the website of the bank or the financial institution to a user via a using a computer-based device. The method further comprises generating by computer the interactive timeline based upon a life event and a life stage of the user along with financial information of the user to provide personalized lifetime financial planning to the user.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is a diagram of computer networked environment in which the overall system and method of the present invention operates.

FIG. 2 is a flow diagram illustrating the method of using the personalized lifetime financial planning tool of the present invention by a user having online internet access.

### DETAILED DESCRIPTION OF THE INVENTION

The following detailed description of the embodiment(s) is merely exemplary in nature and is in no way intended to limit the invention, its application, or uses.

This present invention is directed to an interactive, personalized lifetime financial planning tool for online use by a user of the internet or world wide web via a computer-based device. The term “computer-based” refers to any device that provides access to the internet or world wide web. Examples of computer-based devices include, but are not limited to, a computer, personal data assistant, mobile phone, or other electronic device. Preferably, the interactive tool is offered by a bank or other financial institution on its respective website, and preferably, the user of the interactive tool is a customer of the bank or other financial institution.

The tool permits the user to enter the past, current and projected personal goals and life events of the user. Using this input, the tool provides personalized lifetime financial and investment advice that is tailored to the personal needs, life stage and financial goals of the user. A feature of the tool of the present invention is the manner in which it provides visualization and arrangement of the information to the user as, for example, a graphical narrative or illustration of personal financial states, life events, and goals.

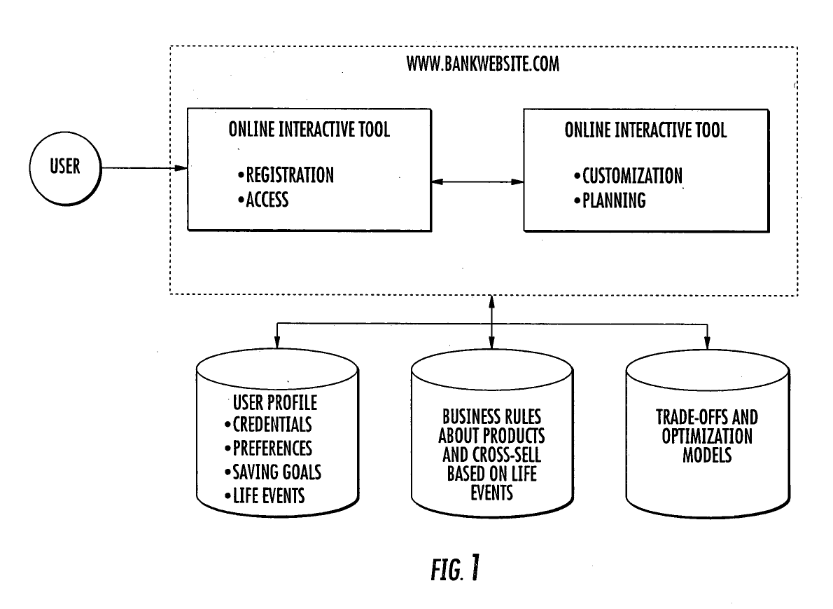

Referring to the figures, FIG. 1 is a diagram of a computer networked environment in which the overall system and computer software tool of the present invention operates. As shown in FIG. 1, a user of the tool accesses a website, preferably of a bank or other financial institution, using a computer-based device. The online tool requests registration of the user prior to providing access to the tool. Registration can be accomplished by any means including, but not limited to, in-person, by phone, online, and by mail. After registration of the user, the tool can be accessed by the user. For example, it could be accessed on the main webpage of the website, by a computer link to the tool, or through a downloadable icon using the computer-based device. The link to the tool may also be accessed on the same webpage with links to other personal accounts of the user. This is another advantage of the tool of the present invention as opposed to other off-the-shelf or standalone products that are not offered through a bank or other financial institution.

After having gained access to the interactive tool, as illustrated in FIG. 1, the tool provides for customization of the tool to suit the user such that it is personalized and provides for personalized planning using a timeline suited to the user. This is where a user, for example, could add or edit entries using the tool.

The timeline when viewed by the user preferably shows timeline by year, month, or day. The timeline may provide a reminder of a scheduled event such as purchase of a car or a reminder of the time until the occurrence of an event. The tool can provide a dropdown menu or box to create a new event and to select the month, day, and year for the event. A user who is also a customer of the bank or financial institution can also view this information on the same screen as other financial account information of the user such as with account name, account number, posted balance, and available balance. The tool can be accessible with other online banking functionality such as transfer funds, pay bills, brokerage, customer service, and view accounts.

As shown in FIG. 1, information related to the user is stored in one or more databases for later use. For examples, databases may be used to store a user profile, business rules about products and for cross-sell based upon life events, and trade-offs and optimization models. Examples of information stored relating to the user profile include, but are not limited to, credentials, preferences, savings goals, and life events. The information stored in the databases is retrievable by the interactive tool. Additionally, the tool can have an interface with existing back-end computer systems. Data from back-end systems can be used to pre-fill or populate the tool if, for example, the user is an existing customer.

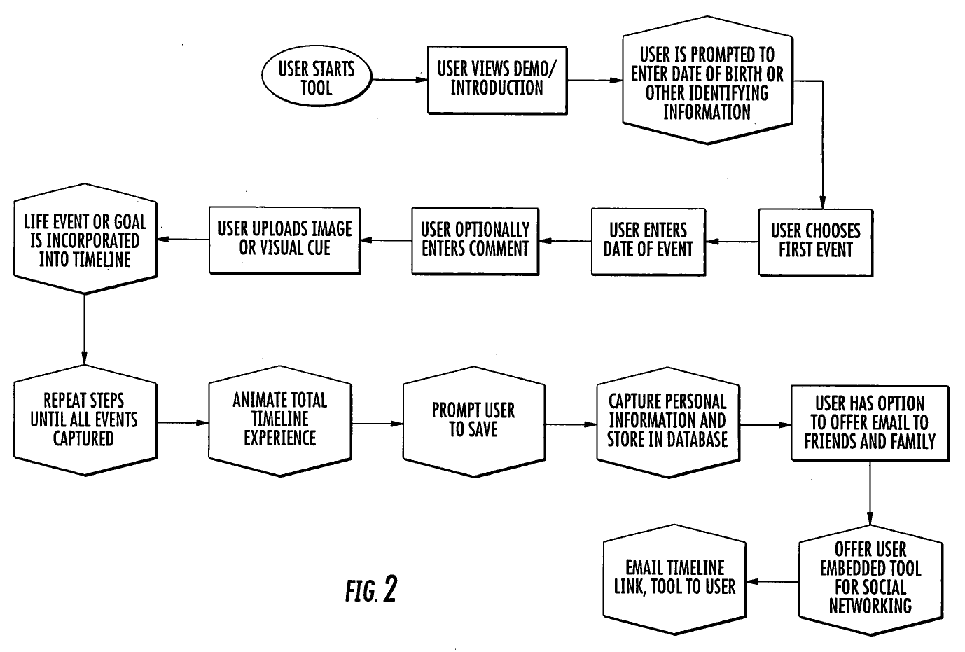

FIG. 2 is a flow diagram illustrating a method of using the personalized lifetime financial planning tool of the present invention by a user having registered to use the tool and having accessed the tool online on a website. As shown in FIG. 2, a user starts the tool, the user optionally views a demonstration or introduction to the tool, and the user is prompted to enter personally identifiable information such as date of birth. The user chooses a first event and enters the date of the event. The user optionally enters a comment. The user uploads an image or visual cue to represent a life event or a goal, or alternatively, creates his or her own. The life event or goal is incorporated into a timeline. Additional information related to financial planning can be entered as necessary including, but not limited to, budgeting, lifestyle, spending habits and other dimensions that influence the financial profile of a user. The event entry steps are repeated until all events of the user are captured by the tool. The tool animates the total timeline experience. The user is prompted to save the information. The personal information of the user is captured and stored in a database. The user has the option to send an email to friends and family regarding his or her use of the tool. The tool may optionally offer to the user the ability to use the tool for social networking or online interaction with others, online or otherwise. If so, the timeline, link, or tool for this functionality may be emailed to the user.

The tool of the present invention is multidimensional. The tool takes into consideration multiple life events and needs happening at the same time just as people make everyday decisions. For example, the tool is applicable in a one to one relationship, namely one life stage to one life event. Alternatively, the tool is applicable in a one to many relationship, namely one life stage to multiple life events. For example, buying a car and going on vacation are examples of life events that could occur during the same life stage. However, the tool also captures multiple life stages of a user. The tool and decision making algorithms supporting the tool allow a user to make compromises or trade-offs. Examples of the questions this tool will answer are: Do I buy an expensive car, go on vacation or lease a condo? How much money do I need to I need to invest if I want to get married in three years and go back to school to get an MBA in four years? The tool takes into consideration the holistic way people look at their life events and personal needs.

The personalized lifetime financial planning tool of the present invention allows a user of the tool to obtain financial and investment advice at any given time that is tailored to the personal needs, life stage, and financial goals of the user.

This tool is designed to be an online internet tool that will provide a user with an interactive online experience. This tool is designed to provide a user, who is preferably a customer of a bank or other financial institution, with an engaging and visual experience to receive financial planning and investment advice that meets the life goals of the user. This interactive tool provides the user the ability to build a customized timeline and to place their present and projected personal priorities and life events on the timeline.

For example, a young professional can create a personalized timeline based on personal priorities and needs that is different than a married adult with children going to college. Each user creates online a personalized timeline using the tool of the present invention.

The tool of the present invention permits a user to plan or to project when he or she wants to get married, have children, and buy a house or boat. The computer-generated timeline is interactive and becomes a tool to measure financial status and to provide relevant financial and investment advice and solutions to the user.

The tool provides computer-generated results to project outcome and conveys whether a user is “taken care of” or “on track.” Particular services and products offered by a financial institution or other financial services are applied to assist the user achieve his or her life events and plans.

This tool is applicable to one or more users, such as to members of a household, in order to provide more than one perspective to the lifetime plan. The tool of the present invention allows the user to invite one or more users to participate and create a composite life event timeline. By inviting a partner or other person(s) to participate, the tool considers the goals and needs of each user in order to provide advice and comprehensive financial planning solutions. Using the tool, the co-users learn about making compromises and financial decisions together in order to reach their personal goals. The personalized financial planning tool allows users to see compromises and trade offs that will need to be made in order to reach their personal and financial goals in this composite timeline. The results of outcome are preferably conveyed to the users as whether they are “taken care of” or “on track.”

The tool allows a user to input various life events, financial information, financial and personal goals and other data in order to create a big picture view of planning needs. The tool incorporates as inputs key life events such as graduations, marriage, divorce, relocations, jobs, birth of children, buying a car and other key life events. The tool allows the user to input the projected amount of money the user needs in order to make a critical purchase such as buying a house or a luxury car. The user is able to customize their big picture view according to their past, current and projected events.

This personalized interactive financial planning tool permits a user to build a timeline with his or her present and projected personal priorities. A user of the tool can change his or her priorities across the timeline and as the priorities change the tool modifies the financial advice to fit the new parameters. The tool is highly personalized based on the ever changing needs of each person across each life stage or lifecycle. The tool comprises existing or state-of-the art industry or economic models or algorithms for determining costs associated with certain life events. For example, a model or algorithm for determining cost of living, home mortgage, cost of relocation, and a car loan monthly payment can be incorporated in the tool. The output and costs provided to the user can be big picture or as minute as grocery bill line items.

The purpose of the invention is to monitor and capture details of the life of the user in a historical timeline or lifeline. The tool is used to store past events and occurrences such as an inheritance or birth, store present events or occurrences, and store future goals or plans. Thus, the tool is a lifetime tool storing past, present, and future event information as well as costs associated therewith.

The personalized lifetime financial planning tool provides for lifetime planning by tracking key life events and key life stages. Examples of key life events include, but are not limited to, graduation, marriage, childbirth, divorce, move, relocation, first job, job change, first automobile, purchase or sale of an automobile, first house, and purchase or sale of a house. Examples of key life stages include, but are not limited to, early-life such as savings and debt control; mid-life such as investments, savings, and estate planning; and end-of-life such as retirement and leaving a legacy.

The tool is preferably combinable with other functionality associated with a website and product and service offerings of a bank or other financial institution. A bank or other financial institution can encourage use of the tool by offering a user of the tool incentives such as lower interest rates on loans or checking/savings accounts and other investment or product offerings.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A networked computer system, the system comprising:
a user,
a website of a bank or a financial institution, and
a computer software tool, wherein the computer software tool is accessible on the website of the bank or the financial institution for providing personalized financial planning to the user based upon financial information of the user along with a life event and a life stage of the user in an interactive timeline.

2. The networked computer system according to claim 1, wherein the user is a customer of the bank or the financial institution.

3. The networked computer system according to claim 1, the system further comprising a computer database for storing personal information, financial information, life events, goals, or a combination thereof, of the user.

4. The networked computer system according to claim 3, wherein the computer database stores a user profile, a business rule, product information, a model, or a combination thereof.

5. The networked computer system according to claim 1, wherein the tool offers a compromise or trade-off to the user for consideration in the financial planning of the user.

6. The networked computer system according to claim 6, wherein one or more life events are associated with the life stage of the user.

7. A networked computer system, the system comprising:
a first user,
a second user,
a website of a bank or a financial institution, and
a computer software tool, wherein the computer software tool is accessible on the website of the bank or the financial institution for providing personalized financial planning to the first user and the second user based upon financial information of the users along with life events and life stages of the users in an interactive composite timeline.

8. The networked computer system according to claim 7, wherein the first user and the second user are members of the same household.

9. The networked computer system according to claim 7, wherein the first user and the second user are family members

10. The networked computer system according to claim 7, wherein the computer software tool offers the user the ability to use the tool for social networking or online interaction with others.

11. The networked computer system according to claim 7, wherein the user is a customer of the bank or the financial institution.

12. The networked computer system according to claim 7, the system further comprising a computer database for storing personal information, financial information, life events, or a combination thereof, of the user.

13. The networked computer system according to claim 12, wherein the computer database stores a user profile, a business rule, product information, a model, or a combination thereof.

14. The networked computer system according to claim 7, wherein the tool offers a compromise or trade-off to the user for consideration in the financial planning of the user.

15. The networked computer system according to claim 7, wherein one or more life events are associated with the life stage of the first user or second user.

16. A web-based online computer tool comprising:
an interactive timeline accessible on the website of a bank or a financial institution generated based upon a life event and a life stage of the user along with financial information of the user to provide personalized lifetime financial planning to the user.

17. The computer tool according to claim 16, wherein the tool provides an automated reminder to the user based upon information of the user present in the timeline.

18. The computer tool according to claim 16, wherein the timeline comprises a past event, a present event, a future event, or a combination thereof of the user.

19. The computer tool according to claim 16, wherein one or more life events are associated with the life stage of the user.

20. A method of using a computer tool, the method comprising:
offering by a bank or a financial institution a web-based online computer tool comprising an interactive timeline accessible on the website of the bank or the financial institution to a user, and
generating by computer the interactive timeline based upon a life event and a life stage of the user along with financial information of the user to provide personalized lifetime financial planning to the user.

21. The method according to claim 20, wherein the user is a customer of the bank or the financial institution.

22. The method according to claim 20, wherein the tool provides an automated reminder to the user based upon information of the user present in the timeline.

23. The method according to claim 20, wherein the timeline comprises a past event, a present event, a future event, or a combination thereof of the user.

24. The method according to claim 20, wherein one or more life events are associated with the life stage of the user.
